(19) United States
(12) Patent Application Publication
(10) Pub. No.: US 2001/0044489 A1
(43) Pub. Date: Nov. 22, 2001

(54) Coating substance with low emissivity in the heat radiation range

(76) Inventor: Gerd Hugo, Schondorf (DE)

Correspondence Address: Killworth, Gottman, Hagan & Schaeff, L.L.P., Suite 500, One Dayton Centre, Dayton, OH, 45402-2023, US

(21) Appl. No.: 09/870,033

(22) Filed: May 30, 2001

Related U.S. Application Data
(63) Continuation of application No. 08/750,030, filed on Nov. 25, 1996, now abandoned.
Application No. 08/750,030 is a 371 of international application No. PCT/DE95/00644, filed on May 11, 1995.

(30) Foreign Application Priority Data
May 25, 1994 (DE) P 44 18 214.7

(51) Int. Cl. C08K 3/30; C08K 3/10

(52) U.S. Cl. 524/420; 524/434; 524/436

(57) ABSTRACT

A coating substance with a low emissivity or high reflectivity in the heat radiation wavelength range. A binder with high transparency in the heat radiation range, especially in the range of wavelengths from 3 to 50 μm, contains particles having a high transparency in this range and the refractive index of which in the heat radiation wavelength range differs from that of the binder.

The invention relates to a coating substance which has a low emissivity in the heat radiation range.

Known coating substances are substantially composed of binders, pigments and different additives. With standard coating substances, the majority of the binders and the dispersed pigments have a high degree of absorption in the heat radiation range, and thereby also have a high degree of heat radiation emission.

A silicon-based wall coating for an external house wall is described here by way of an example. The dispersed pigments which are mainly composed of lime, have, as does the silicon-based binder, high absorption bands in the heat radiation range of the thermal infra-red range of 3 to 100 μm. The degree of emission of the house wall in the heat radiation range is thus over 90%. This means that in addition to the heat losses by convection, that is to say the heat loss to air, the house wall radiates heat energy at Mₛ=ε.σ.T⁴. With a wall temperature of 0° celsius, that is to say 273 Kelvin, this means that with an ε of 0.9, heat is radiated at 2.3 W-m-².

It is important to know that these heat losses from a house by heat radiation are additional, that is to say completely independent of the heat losses by convection. This can be explained in that air is transparent to heat radiation over a wide range, and for heat radiation a drop in temperature is not dependent on the air temperature, but instead dependent on the radiation temperatures of the environment and the sky. When the sky is clear, these temperatures are significantly lower than that of the air.

In addition to avoiding heat losses on the external wall of a house, it is also worthwhile to reduce the transfer of heat by radiation to the inside of the external wall of a house. All items such as furniture, floors, and also in particular the internal walls of the house emit heat in the form of heat radiation according to the regularities described. People themselves also give off heat in the form of radiation towards the inside of the external wall. In particular, heaters naturally also give off radiated heat and although this is in the direction of the internal space it is, however, equally towards the inside of the external wall.

In this case, in accordance with the degree of emission ε>0.9 (degree of emission=degree of absorption) heat radiation is absorbed by over 90%, and transported by heat conduction to the external wall.

To avoid direct transfer of heat by radiation from heaters into the wall, so-called “reflective foils for heaters” are commercially available. The metallic surface of the reflective foils only absorbs approximately 10 to 20% of the heat radiation. The difference from 100% is reflected back into the room, in this case to the heater. Unfortunately these reflective foils are not popular, probably because of their metallic appearance, and are therefore seldom used. In any case, complete lining of a home with such reflective foils would not be sensible as they have no, or very little, moisture diffusion capability and on the other hand would turn the room into a Faraday cage in which nobody would wish to live. It also would not correspond to our aesthetic concepts of interior design.

With respect to energy-saving, it would however be worthwhile to, as it were, inwardly metal-coat a room so that the heat radiation is reflected back into the room. Nevertheless this must relate to a moisture permeable layer which does not make the room a Faraday cage and which also complies with aesthetic requirements.

The increasing air pollution which is to a great extent caused by the burning of fossil fuels for heating houses, and also the knowledge that the reserves of fossil fuels will at some time be exhausted, make it necessary to use all possibilities for minimising the energy requirement.

The object of the invention is to provide an improved coating substance, with the aid of which energy can be saved. Further, a process for manufacturing coating pigments should be found which can be used with these coating substances.

This object is solved according to the features described in claim 1 and claim 8. Advantageous further developments of the subject-matter of the invention are described in the dependent claims. Further, the object is solved with respect to the process in claim 11.

In an unexpected manner it has been shown that in accordance with the invention, a coating substance with properties of low emissivity in the heat radiation range can be manufactured by dispersion of particles which are highly transparent in the heat radiation range, and the refractive index of which is greater or smaller in the heat radiation range and is in any case different to the refractive index of the binder, wherein the binder has a high degree of permeability in the heat radiation range. Such a coating substance has no disadvantageous effects in the visible range.

Particularly good results are obtained when the product of the refractive index of the individual particles in the thermal infra-red range and the particle diameter is substantially equal to half the wave length of the wavelength range in which the coating substance should have a low emissivity effect. Slight shifts result from the refractive index of the binder in which the particles are dispersed. The greater the refractive index of the binder, the greater the shift in the average wavelength towards the longer wavelength range. Preferably, the percentage of the filling ratio of the particles in the binder should be at 20 to 70%, in particular 30 to 50%, with reference to the volumes of the total coating.

The degree of the reflection or of the emission is determined by the difference between the refractive power of the binder and the refractive power of the dispersed particles. The greater the difference, the higher the desired reflectivity present. The refractive indices of binders with high transparency in the heat radiation range are normally in the range of 1.3 to 1.7. A large difference in the refractive index can above all be produced when the refractive index of the particles is greater than that of the binder. Preferably it should be in the range of 2 to 4, but higher refractive indices of the particles are also conceivable. If the refractive index of the particles is less than that of the binder, it should if possible be in the range of that of air, that is to say 1.

The band width of the range in which the low emission and high reflectivity has to be produced is also dependent on the size of the difference between the refractive index of the binder and that of the particles. The greater the difference in the refractive index of the two materials, the greater the band width by the average wavelength selected. With a difference in refractive index of 2(n_{binder}=1.5; n_{particles}=3.5) a band width results for the first resonance of approximately 6 μm. With this, the range of the atmospheric window, which is of military relevance, can be designed with low emissivity or reflectivity of 8-14 μm. The range relevant for 300 kelvin radiators can thus be designed with low emissivity and reflectivity at 8-14 μm, where the atmosphere has a high transparency and thus allows energy through into space. Subsequent resonances are also produced in the relevant atmospheric window at 3-5 μm up to the range of visible light.

As material for the dispersed particles, all materials with high transparency in the heat radiation range can be considered, which have a greater or smaller refractive index than the binder in the heat radiation range.

Particularly advantageous materials within the framework of the invention for the particles which are dispersed in the binder can be selected in particular from the group of the following: germanium, silicon, metal sulphides such as, for example, lead sulphide, metal selenides such as, for example zinc selenide, metal tellurides or tellurium itself, chlorides such as, for example, sodium and potassium chloride, fluorides such as, for example, calcium fluoride, lithium fluoride, barium fluoride and sodium fluoride, and antimonides such as, for example, indium antimonide.

The choice of materials which are transparent in the wavelength range of heat radiation and also have a different refractive index to the binder is limited. According to the invention, particles with an artificially increased or reduced refractive index can also be used for this application.

To provide particles with an artificially increased refractive index, organic or inorganic binders with high transparency in the heat radiation range are loaded with 10 to 50 percent by volume of colloidal metal powder with a particle size in the range of 0.05 to 1 μm, such that the colloidal particles are uniformly distributed in the binder. The binder loaded in this way is dried and after drying is comminuted to the desired grain size conforming to the refractive index of the material obtained. Because of the extremely small size of the colloid metal particles there is no disadvantageous increase in reflectivity in other wavelength ranges.

Depending on the degree of loading with colloidal metal powder and the refractive index of the binder, particles can be manufactured with a refractive index significantly above that of the initial material. With a filling ratio of 30 percent by volume of colloidal copper, the average particle size of which was below 0.5 μm, the refractive index of the molten polyethylene mass used as the binder could be increased from 1.5 to 2.2. The polyethylene loaded in this manner was subsequently cooled with liquid nitrogen and comminuted to the desired particle size of 2.5 μm.

As the low emissivity of the coating substance according to the invention is achieved above all because the refractive indices of the dispersed particles and the binder are different, according to the invention low emissivity can also be obtained by dispersion of air, that is to say a filler with a low refractive index, in a binder. In principle the same conditions apply here as in the case already described. An optimum effect is obtained when the diameter of the air-filled hollow spaces is substantially the same size as half the average wavelength of the range in which a low emissivity and high reflectivity is desired. The hollow spaces can also be placed in the binder by mechanical means using spray techniques, or by means of known chemical reactions.

With the methods described until now for producing a low emissivity coating substance, it was possible to determine the wavelength ranges in which the colours should be of low emissivity or reflectivity by means in particular of the size but also to a limited extent by the filling volume or the filling ratio of the particles dispersed in a binder. If, however, a low emissivity colour with as wide a band width as possible is desired, pre-formed hollow micro-spheres known per se, the wall material of which must nonetheless be transparent in the heat radiation range and can be composed from the materials described above, are suitable for this purpose. It is also possible in this case to artificially increase the refractive index of the wall material by dispersion of colloidal metal particles. The loading ratio of a binder with the hollow micro-spheres transparent in the heat radiation range is not crucial, but the higher the loading ratio, the lower the heat emissivity of a coating so produced. The diameter of the hollow micro-spheres should be in the range of 5-500 μm, but in particular 10 to 200 μm.

A further way to produce a low emissivity coating substance is to disperse plate-like, flaky pigments which are made from materials which are transparent in the heat radiation range and can originate from the range of the materials already described or materials transparent in the heat radiation range per se, the refractive index of which is artificially adjusted by the dispersion of colloidal metal particles.

Such plate-like interference pigments are known from the area of special effect paints and varnishes for the cosmetic industry or also for the automotive industry. In DE OS 32 21 045 pearl gloss pigments based on coated mica chips are described. Their effectiveness is limited to the visible range, however, as their interference producing shapes are specially dimensioned for the visible light range and because the materials used are not transparent in the heat radiation range and act in an absorbent manner. Various methods for manufacturing such plate-like pigments are known. In most cases, substances are chemically deposited on mica plates. However, manufacturing methods are also known in which paint layers are applied to a moving drying belt, for example with a squeegee, for subsequent comminution to produce pigments.

With the latterly described method particularly inexpensive interference pigments with good effectiveness in the heat radiation range can be produced in the following manner. Preferably three layers of, in particular, organic materials transparent in the heat radiation range are applied, by means of which a different refractive index is created by the different loading ratio of colloidal metal particles. Firstly a layer with as high a refractive index as possible is applied, then follows a layer with the lowest possible refractive index, and the last layer again has a high refractive index, wherein before application of the next layer, each layer is dried so that the layers do not run into one another. The designation of the highest possible or lower refractive index of the material for the respective layer is in accordance with the relationship to the refractive index of the binder used.

After drying and pulverisation, interference pigments are obtained with high reflectivity and low emissivity in the heat radiation range which are dispersed in a binder permeable in the heat radiation range and these together produce a coating substance effective in the heat radiation range.

Binders are preferred in the framework of the invention which are highly transparent in the heat radiation range such as, for example, cyclised or chlorine rubber and bitumen binders. If good resistance to oil, benzine and chemicals is required, binders are preferred within the framework of the invention which are selected from the group including the polyurethane, acrylate, PVC polymer mixtures, polyethylene/vinyl acetate polymer mixtures, butyl rubber and silicon alkyd resins groups. Depending on requirements, modified aqueous polyethylene-based binders, such as Poligen PE and Poligen WE1 from BASF Ludwigshafen can be used. Mixtures of polyethylene binders with aqueous acrylate binders.

Some examples of manufacturing of the coating substance according to the invention are given hereinafter.

### EXAMPLE 1

40 percent by volume, based on the solids content of the binder, of a silicon powder with an average grain size of 1.7 μm and a refractive index of approximately 3.5 in the heat radiation range is applied to a conventional chlorine rubber-based paint binder with a refractive index of approximately 1.6 in the heat radiation range. In order to largely avoid settling of the particles in the binder, the paint film is subjected to rapid drying at 80 degrees celsius in a furnace. When subsequent measurement of the reflectivity and emissivity of the dark grey paint is done, an average emissivity of 20% (80% reflectivity) is determined in the 4.5 to 6 μm and 8 to 13 μm wavelength range.

### EXAMPLE 2

Multiple sheets of polyethylene are sprayed onto a primed metal plate up to a total thickness of 0.5 mm with an air-pressure driven spray pistol for hot glue with a metered air supply. Due to the metered air supply, hollow micro-spheres occur in the polyethylene, the diameter of which is in the range of 5 to 10 μm. A ratio of 50 percent by volume of air to binder was determined by weighing. During subsequent measurement of the reflectivity and emissivity properties of the layer an average degree of emissivity of 65% (35% reflectivity) was determined in the 4.5 to 5 μm and 8 to 12 μm wavelength range.

### EXAMPLE 3

30 percent by volume of copper particles with an average grain size of 0.5 μm are dispersed in a molten polyethylene mass and distributed in the molten mass using a standard working method. The polyethylene loaded in this way was subsequently cooled with liquid nitrogen and ground to an average particle size of 3.5 μm. The particles obtained in this way were dispersed at up to 35 percent by volume in a conventional cyclised rubber-based binder. The mixture was coloured green with conventional transparent colorants and painted onto a primed metal plate. During the subsequent measurement of the reflectivity and emissivity properties of the coating substance a wide banded degree of emissivity of 75% (25% reflectivity) in the whole heat radiation wavelength range was determined, with deviations in the 4.5 to 5 μm and 8 to 12 μm ranges. In these ranges, the degree of emissivity was 35% (65% reflectivity).

### EXAMPLE 4

Up to 50% by volume of hollow micro-spheres made from a silicon-based material transparent in the heat radiation range and calcium fluoride and various oxides were dispersed in an aqueous dispersion of Poligen WE1, a polyethylene oxidate from BASF, for reducing the melting point. The diameter of the hollow micro-spheres was in the range of 30 to 80 μm with wall thicknesses in the range of 1 to 3 μm. The mixture was coloured white with ultrafine (less than 1 μm diameter) white pigments made from zinc sulphide and subsequently measured with respect to its emissivity properties in the heat radiation range. A degree of emissivity of 30% (70% reflectivity) was determined over the whole heat radiation range. Only in the 4 to 6 μm range was the degree of emissivity 65% (35% reflectivity).

### EXAMPLE 5

30 percent by volume of copper particles with an average diameter of less than 0.5 μm was dispersed in a conventional cyclised rubber-based binder highly transparent in the heat radiation range. The mixture was diluted with a solvent such that after drying of the paint sprayed onto a Teflon plate there was a film thickness of 1 to 1.5 μm. A further film of a cyclised rubber paint without the copper particles, the layer thickness of which was 2 to 3 μm after drying and hardening, was sprayed onto the hardened film. Afterwards the layer with the copper particles was then applied to this second layer. The layer obtained in this way was scraped off the Teflon plate and crushed in the mortar. After sieving out excessively finely ground dust particles, the plate-like layer pigments, transparent in the heat radiation range, were viewed under the microscope. The dimensions of their area were between 10 to 20 μm and the thickness of the layer 4 to 8 μm. Due to layer building using different refractive indices, the layer pigments had a high reflectivity in the heat radiation range. 25 percent by volume of the layer pigments were dispersed in a modified Poligen WE1 dispersion from BASF and after colour tinting were coloured white with ultra-fine (less than 1 μm diameter) white pigments measured in the wavelength range of heat radiation. The emission in the 6 to 14 μm wavelength range was 35% (reflectivity 65%) and in the 2 to 5 μm wavelength range was 70% (30% reflectivity).

1. Coating substance with a low emissivity and a high reflectivity in the heat radiation wavelength range, characterised in that in a binder with high transparency in the heat radiation range, in particular in the 3 to 5 μm wavelength range particles are dispersed which have a high transparency in this wavelength range and the refractive index of which is different from the refractive index of the binder in the heat radiation wavelength range.

2. Coating substance according to claim 1, characterised in that the particles have a diameter which is the product of half the average wavelength of the desired wavelength range for reflectivity, multiplied by the refractive index of the particles on the heat radiation range.

3. Coating substance according to claim 1, characterised in that the particles are hollow micro-spheres with a diameter of 5 to 500 μm, in particular 10 to 200 μm, and filled with a gas which is not absorbent in the heat radiation range, and that the wall material is transparent in the heat radiation range and which has a refractive index which is equal to or greater than that of the binder.

4. Coating substance according to claim 1, characterised in that the particles are formed from a laminated pigment which has at least three layers, wherein a first inner layer has a lower refractive index than the two outer layers.

5. Coating substance according to claim 4, characterised in that the wavelength range in which reflectivity has to occur is adjustable by means of the thickness of the individual layers.

6. Coating substance according to claim 4 or 5, characterised in that the percentage of the loading ratio of the binder with the particles is 10 to 70 percent, preferably 20 to 50 percent in relation to the volume of the whole layer.

7. Coating substance according to claim 1, characterised in that the material from which the particles is formed contains colloidal metal particles with a diameter of 0.05 to 1 μm, by means of which its refractive index can be increased.

8. Coating substance with a low emissivity and high reflectivity in the heat radiation wavelength range, characterised in that the coating substance is composed of a binder with high transparency in the heat radiation range, in particular in the 3 μm to 50 μm wavelength range, in which gas inclusions in the order of 5 μm to 50 μm are contained.

9. Coating substance according to one of the preceding claims, characterised in that the particles dispersed in the binder are composed of at least one material which is selected from the group of the following materials: germanium, silicon, metal sulphides such as, for example, lead sulphide, metal selenides such as, for example zinc selenide, metal tellurides or tellurium itself, chlorides such as, for example, sodium and potassium chloride, fluorides such as, for example, calcium fluoride, lithium fluoride, barium fluoride and sodium fluoride, and antimonides such as, for example, indium antimonide.

10. Coating substance according to one of the preceding claims, characterised in that the binder includes at least one material which is selected from the group of the following materials: polyurethane, acrylate, PVC polymer mixtures, polyethylene/vinyl acetate polymer mixtures, butyl rubber and silicon alkyd resins, modified aqueous polyethylene-based binders, and mixtures of aqueous polyethylene-based binders with those based on acrylates.

11. Process for manufacturing layered pigments, characterised in that on a first layer made from a material transparent in the heat radiation range with a first refractive index in this wavelength range, there is applied a second layer made from a material transparent in the heat radiation range with a second refractive index, and on this is applied a third layer made from a material transparent in the heat radiation range with a third refractive index, and that after drying these layers are comminuted to produce pigments.

12. Process according to claim 11, characterised in that the refractive index of the second layer is less than the refractive index of the first and third layers.

13. Process according to claims 11 and 12, characterised in that the refractive indices of the first and third layers are the same.
